(19) United States
(12) Patent Application Publication
(10) Pub. No.: US 2024/0144425 A1
(43) Pub. Date: May 2, 2024

(54) IMAGE COMPRESSION AUGMENTED WITH A LEARNING-BASED SUPER RESOLUTION MODEL

(71) Applicants: International Business Machines Corporation, Armonk, NY (US); The Board of Trustees of the University of Illinois, Urbana, IL (US)

(72) Inventors: Jinjun XIONG, Goldens Bridge, NY (US); Nicholas CHEN, Chicago, IL (US); James WEI, San Francisco, CA (US); Vikram Sharma MAILTHODY, Urbana, IL (US)

(21) Appl. No.: 18/051,545

(22) Filed: Nov. 1, 2022

(51) Int. Cl. G06T 3/40; G06N 20/20

(52) U.S. Cl. CPC G06T 3/4053; G06N 20/20

(57) ABSTRACT

Techniques for using machine learning (ML) for image processing are disclosed. First encoded image data, generated by encoding a first one or more digital images using an encoder, is received. A first reconstructed one or more digital images are generated by decoding the encoded image data using a decoder corresponding to the encoder. A second reconstructed one or more digital images are generated by transforming the first reconstructed one or more digital images using a super-resolution ML model. The second reconstructed one or more digital images has a higher image resolution compared with the first reconstructed one or more digital images, and the super-resolution ML model is trained based on an image resolution corresponding to at least one of the second reconstructed one or more digital images.

### STATEMENT REGARDING PRIOR DISCLOSURES BY THE INVENTOR OR A JOINT INVENTOR

The following disclosure(s) are submitted under 35 U.S.C. 102(b)(1)(A):
DISCLOSURE: Super-Resolution Augmented Image Compression, Jinjun Xiong, Nicholas Chen, James Wei, Vikram Mailthody, May 19, 2022.

### BACKGROUND

The present invention relates to image compression and, more specifically, to machine learning (ML) techniques for image compression.

### SUMMARY

Embodiments include a method. The method includes receiving encoded image data, wherein the encoded image data was generated by encoding a first one or more digital images using an encoder. The method further includes generating a first reconstructed one or more digital images by decoding the encoded image data using a decoder corresponding to the encoder. The method further includes generating a second reconstructed one or more digital images by transforming the first reconstructed one or more digital images using a super-resolution machine learning (ML) model. The second reconstructed one or more digital images has a higher image resolution compared with the first reconstructed one or more digital images, and the super-resolution ML model is trained based on an image resolution corresponding to at least one of the second reconstructed one or more digital images.

Embodiments further include a system. The system includes a processor, and a memory having instructions stored thereon which, when executed on the processor, performs operations. The operations include receiving encoded image data, wherein the encoded image data was generated by encoding a first one or more digital images using an encoder. The operations further include generating a first reconstructed one or more digital images by decoding the encoded image data using a decoder corresponding to the encoder. The operations further include generating a second reconstructed one or more digital images by transforming the first reconstructed one or more digital images using a super-resolution ML model. The second reconstructed one or more digital images has a higher image resolution compared with the first reconstructed one or more digital images, and the super-resolution ML model is trained based on an image resolution corresponding to at least one of the second reconstructed one or more digital images.

Embodiments further include a computer program product, including a computer-readable storage medium having computer-readable program code embodied therewith, the computer-readable program code executable by one or more computer processors to perform operations. The operations include receiving encoded image data, wherein the encoded image data was generated by encoding a first one or more digital images using an encoder. The operations further include generating a first reconstructed one or more digital images by decoding the encoded image data using a decoder corresponding to the encoder. The operations further include generating a second reconstructed one or more digital images by transforming the first reconstructed one or more digital images using a super-resolution ML model. The second reconstructed one or more digital images has a higher image resolution compared with the first reconstructed one or more digital images, and the super-resolution ML model is trained based on an image resolution corresponding to at least one of the second reconstructed one or more digital images.

### BRIEF DESCRIPTION OF THE DRAWINGS

FIG. 1 illustrates image compression using a learning-based super resolution model computing environment, according to one embodiment.

FIG. 2 is a block diagram of a controller and user device for image compression using a learning-based super resolution model, according to one embodiment.

FIG. 3 is a flowchart illustrating image compression using a learning-based super resolution model, according to one embodiment.

FIG. 4 is a flowchart illustrating training techniques for image compression using a learning-based super resolution model, according to one embodiment.

FIG. 5 illustrates a frozen media transformation and encoder with a jointly trained decoder for image compression using a learning-based super resolution model, according to one embodiment.

FIG. 6 illustrates individual end to end training for image compression using a learning-based super resolution model, according to one embodiment.

FIG. 7 illustrates transferred end to end training for image compression using a learning-based super resolution model, according to one embodiment.

FIG. 8 illustrates a cloud computing node, according to one embodiment.

FIG. 9 illustrates a cloud computing environment, according to one embodiment.

FIG. 10 illustrates abstraction model layers, according to one embodiment.

### DETAILED DESCRIPTION

Image and video data consumption is steadily growing as social media, video streaming, autonomous driving, large scale data analysis, among other applications become more and more popular. Image and video quality are imperative for good user experiences in many of these applications. In particular, high resolution images and videos are increasingly demanded (e.g., for entertainment, health-care, and numerous other applications).

Further, Internet of Things (IoT) devices, edge devices, and mobile devices are becoming increasingly prevalent as both producers and consumers of image and video data. These devices commonly have limited battery, computational power and storage, and vary widely in display resolution and characteristics. The cost of storage and network communication bandwidth is also growing as more accessible high-resolution cameras (e.g., through smart phones and tablets) continuously produce larger image sizes. This places great pressure on image storage and transmission bandwidth and drives a need for accurate, efficient, and flexible image and video compression techniques.

Some existing image and video compression techniques use machine learning (ML). For example, deep learning techniques can sometimes surpass traditional compression techniques (e.g., JPEG, BPG, HEVC, etc.) in a variety of quantitative metrics. However, these existing ML-based image and video compression techniques are prohibitively slow in terms of compression throughput. For example, graphics processing unit (GPU) accelerated JPEG encoding can reach over 6000 MB/sec, while existing ML based compression is hundreds of times slower.

JPEG encoding and other traditional image and video compression techniques (e.g., BPG, HEVC, etc.) are computationally efficient and run quickly, but yield lower quality images than existing learning-based compression techniques. These traditional compression techniques generally have higher distortion and lower perceptual quality at the same bitrates when compared with existing learning-based compression techniques. Further, traditional compression techniques generally require years of manual design of various filters, arithmetic coding blocks, and other heuristic modules, which introduces significant friction and cost to the deployment process.

To meet the needs of diverse client devices, both learning-based and traditional compression techniques also generally require service providers to compress and store multiple image resolutions. This increases both computation and storage costs.

One or more techniques described herein solve these prohibitive shortcomings of prior techniques by incorporating a deep learning-based image super-resolution into efficient end-to-end compression. This can provide greatly increased compression throughput and reduced file size, along with higher perceptual image quality compared with existing techniques operating at comparable bitrates.

One or more of these techniques can, further, flexibly produce a target image of any desired target resolution, making the techniques capable of serving flexible source and sink device pairs (e.g., source and sink devices with a wide variety of mis-matched display resolutions).

In an embodiment, one or more of these techniques provides significant technical advantages. For example, many industry applications must process and compress a massive deluge of image and video media data before serving to a recipient. These applications include social media platforms, video streaming websites, and web conferencing services, among other applications. One or more techniques described herein provide a drastic improvement in throughput, that allows applications to process more content with fewer compute resources. Further, one or more techniques described herein save significantly on storage costs by providing flexible compression that only stores a single source image resolution, saving service providers significant storage and compute costs. These techniques are described further in the paper “Super-Resolution Augmented Image Compression”, submitted along with this application and incorporated herein by reference.

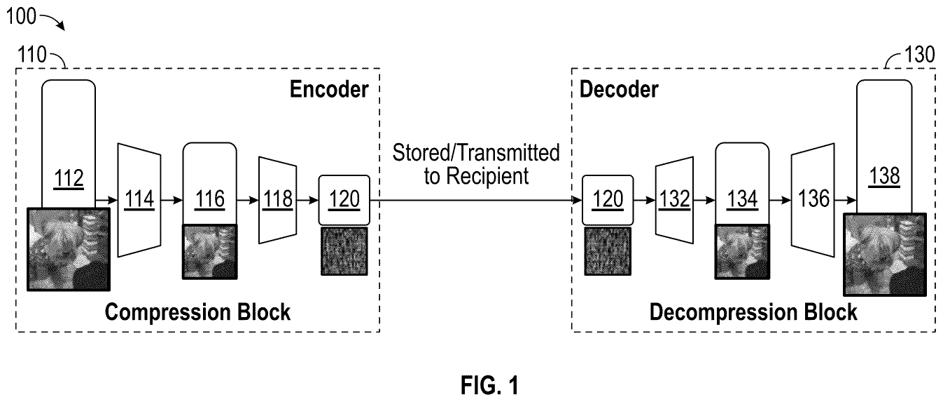

FIG. 1 illustrates image compression using a learning-based super resolution model computing environment 100, according to one embodiment. In an embodiment, a compression block 110 includes a series of sequential layers to compress image data. An input digital image 112 (e.g., an image, video frame, or collection of video frames) is provided to a media transformation layer 114. The media transformation layer 114 applies a transformation to the input digital image 112 to down-sample the input digital image 112 and generate a lower resolution image 116. In an embodiment, the lower resolution image 116 is down-sampled from the input digital image 112 and has a lower resolution than the input digital image 112 such that it includes fewer pixels than the input digital image 112. In an embodiment, the input digital image 112 is an individual digital image. Alternatively, or in addition, the input digital image 112 is a frame of a digital video. As another alternative, or again in addition, the input digital image is a collection of frames of a digital video (e.g., a sequence of frames, a collection of individual frames, or any other collection of frames). While embodiments below are discussed in terms of a digital image, these techniques can equally be applied to digital video (e.g., to one or more frames of digital video).

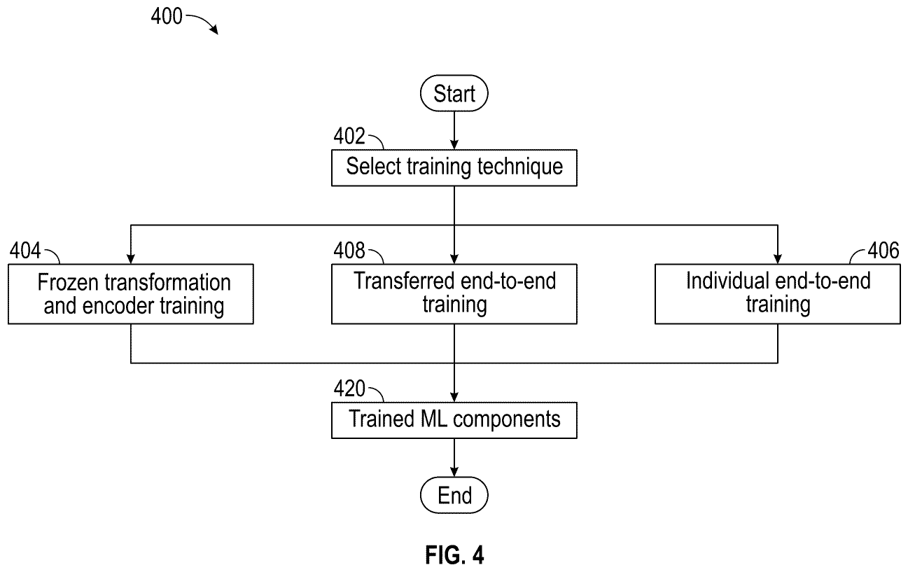

The media transformation layer 114 can use any suitable transformation technique to down-sample the input digital image 112 and transform the input digital image 112 into the lower resolution image 116, including a bicubic interpolation (e.g., bicubic down-sampling with noise injection), a bilinear interpolation, a nearest-neighbor interpolation, or any other suitable transformation techniques. Further, the media transformation layer 114 can used a learned transformation (e.g., a trained deep-learning ML model, or any other suitable ML techniques). This is discussed further, below, with regard to FIGS. 4-7.

In an embodiment, the lower resolution image 116 (e.g., lower resolution relative to the input digital image 112) is encoded using an encoder 118 to generate a latent representation 120 of the image data. In an embodiment, the latent representation 120 provides a minimum (or near-minimum) amount of data necessary to generate a final rendered image (e.g., at a destination). The encoder 118 can be any suitable encoder. In an embodiment, the encoder 118 is a learned encoder (e.g., a deep learning ML encoder). For example, a deep neural network can learn to transform an input digital image to a lower dimensional latent representation that retains important visual information, as described in “Variational Image Compression with a Scale Hyperprior”, by Balle et al. (BMSHJ) in ICLR (2018). This is discussed further, below, with regard to FIGS. 4-7.

In an embodiment, the latent representation 120 is transmitted from a source (e.g., a source implementing the compression block 110) to a destination (e.g., a destination implementing a decompression block 130). Alternatively, or in addition, the latent representation 120 is stored (e.g., at a suitable electronic repository) and accessed by the decompression block 130 from storage. The decompression block includes a series of sequential layers to decompress a previously-compressed image. For example, a decoder 132 can be used to generate a lower resolution image 134 from the latent representation 120. In an embodiment, the lower resolution image 134 is analogous to the lower resolution image 116 generated by the compression block 110, though it may not be precisely identical (e.g., because of imperfect encoding by the encoder 118 and decoding by the decoder 132). The lower resolution image 134 and is lower resolution than the final reconstructed image 138.

In an embodiment, the decoder 132 corresponds to the encoder 118. For example, the decoder 132 is paired with the encoder 118 and the decoder 132 is designed to decode the image data encoded using the encoder 118 (e.g., the decoder 132 is the reverse of the encoder 118). The decoder 132 can be any suitable decoder. In an embodiment, the decoder 132 is a learned decoder (e.g., a deep learning ML decoder). For example, a deep neural network with deconvolution and upsampling layers can be used. This is discussed further, below, with regard to FIGS. 4-7.

In an embodiment, the lower resolution image 134 is transformed using a super resolution 136. The super resolution 136 can use any suitable transformation technique. In an embodiment, the super resolution 136 is a learned transformation (e.g., a deep learning ML transformation). For example, the super resolution 136 can be a RealSR super-resolution model. This is discussed further, below, with regard to FIGS. 4-7.

In an embodiment, the super resolution 136 generates a reconstructed image 138 from a lower resolution image 134. The reconstructed image 138 corresponds to the input digital image 112 used in the compression block 110 (e.g., after compression and decompression). For example, the reconstructed image 138 can be a native resolution image for a destination device. The destination device (e.g., used to view the reconstructed image 138) can be any suitable electronic or computing device, including a smartphone, a tablet, a laptop computer, a desktop computer, or any other suitable device. Critically, with this embodiment, image 138 can be reconstructed in a variety of output resolutions to support heterogeneous destination devices.

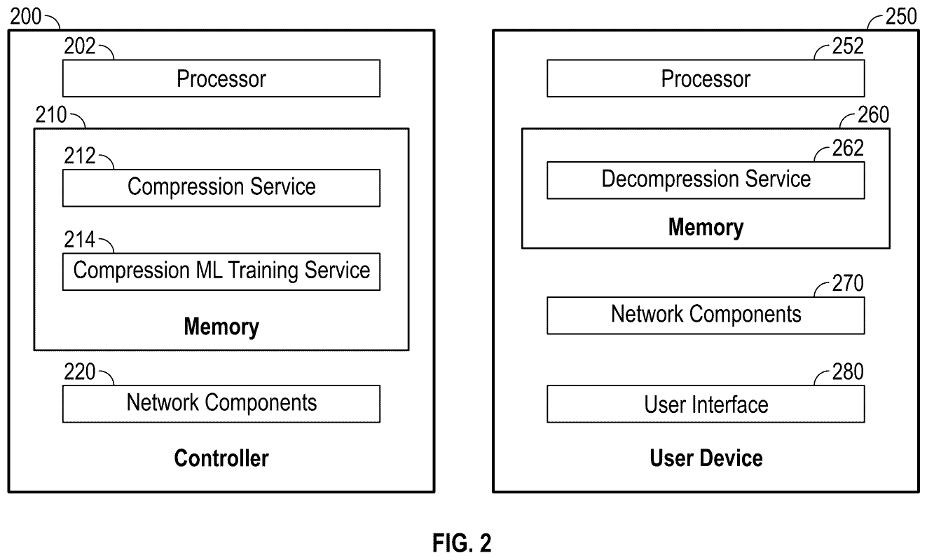

In an embodiment, the compression block 110, the decompression block 130, or both, can be implemented using a suitable controller (e.g., the controller 200 illustrated in FIG. 2) or a suitable user device (e.g., the user device 250 illustrated in FIG. 2), and the latent representation 120 can be transmitted from the source to the destination using a communication network. For example, the compression block 110 can be implemented using a controller associated with an image source application (e.g., a streaming image or video service, a social media application, or any other suitable application) and the decompression block 130 can be implemented using a destination user device. The communication network can be any suitable communication network, including the Internet, a wide area network, a local area network, or a cellular network. Further, the communication network can transmit data using any suitable wired or wireless communication technique (e.g., an Ethernet connection, a WiFi connection, a cellular connection, or any other suitable network connection).

Further, in an embodiment, the compression block 110, the decompression block 130, or both, can be implemented using any suitable combination of physical compute systems, cloud compute nodes and storage locations, or any other suitable implementation. For example, the compression block 110, the decompression block 130, or both, could be implemented using a server or cluster of servers, or a single user computing device or cluster of computing devices. As another example, the compression block 110, the decompression block 130, or both, can be implemented using a combination of compute nodes and storage locations in a suitable cloud environment (e.g., as discussed further below). For example, one or more of the components of the compression block 110, the decompression block 130, or both, can be implemented using a public cloud, a private cloud, a hybrid cloud, or any other suitable implementation.

FIG. 2 is a block diagram of a controller 200 and user device 250 for image compression using a learning-based super resolution model, according to one embodiment. The controller 200 includes a processor 202, a memory 210, and network components 220. The memory 210 may take the form of any non-transitory computer-readable medium. The processor 202 generally retrieves and executes programming instructions stored in the memory 210. The processor 202 is representative of a single central processing unit (CPU), multiple CPUs, a single CPU having multiple processing cores, graphics processing units (GPUs) having multiple execution paths, and the like.

The network components 220 include the components necessary for the controller 200 to interface with a suitable communication network (e.g., a communication network interconnecting various components of the computing environment 100 illustrated in FIG. 1, or interconnecting the computing environment 100 with other computing systems). For example, the network components 220 can include wired, WiFi, or cellular network interface components and associated software. Although the memory 210 is shown as a single entity, the memory 210 may include one or more memory devices having blocks of memory associated with physical addresses, such as random access memory (RAM), read only memory (ROM), flash memory, or other types of volatile and/or non-volatile memory.

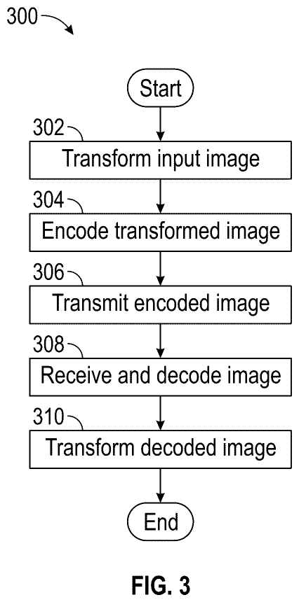

The memory 210 generally includes program code for performing various functions related to use of the controller 200. The program code is generally described as various functional “applications” or “modules” within the memory 210, although alternate implementations may have different functions and/or combinations of functions. Within the memory 210, the compression service 212 facilitates compressing image data (e.g., using ML techniques as discussed above in relation to the compression block 110 illustrated in FIG. 1). The compression ML training service facilitates training ML models for use by the compression service 212 and other components (e.g., ML models used by a decompression service used with a user device 250). This is discussed further, below, with regard to FIGS. 3-7.

The user device 250 can be any suitable user computing device (e.g., a smartphone, a tablet, a streaming media player, a laptop computer, a desktop computer, or any other suitable device). In an embodiment, the user device 250 includes a processor 252, a memory 260, and network components 270. The memory 260 may take the form of any non-transitory computer-readable medium. The processor 252 generally retrieves and executes programming instructions stored in the memory 260. The processor 252 is representative of a single central processing unit (CPU), multiple CPUs, a single CPU having multiple processing cores, graphics processing units (GPUs) having multiple execution paths, and the like.

The network components 270 include the components necessary for the user device 250 to interface with a suitable communication network (e.g., a communication network interconnecting various components of the computing environment 100 illustrated in FIG. 1, or interconnecting the computing environment 100 with other computing systems). For example, the network components 270 can include wired, WiFi, or cellular network interface components and associated software. Although the memory 260 is shown as a single entity, the memory 260 may include one or more memory devices having blocks of memory associated with physical addresses, such as random access memory (RAM), read only memory (ROM), flash memory, or other types of volatile and/or non-volatile memory.

The memory 260 generally includes program code for performing various functions related to use of the user device 250. The program code is generally described as various functional “applications” or “modules” within the memory 260, although alternate implementations may have different functions and/or combinations of functions. Within the memory 260, the decompression service 262 facilitates decompressing image data (e.g., using ML techniques as discussed above in relation to the decompression block 130 illustrated in FIG. 1). This is discussed further, below, with regard to FIGS. 3-7.

The user interface 280 provides any suitable user interface for the user device 250. For example, the user interface 280 can provide a visual interface to allow a user to view a reconstructed image generated using the decompression service 262. The user interface 280 can display the image at any suitable resolution.

While the controller 200 and user device 250 are each illustrated as a single entity, in an embodiment, the various components can be implemented using any suitable combination of physical compute systems, cloud compute nodes and storage locations, or any other suitable implementation. For example, the controller 200 and user device 250 could each be implemented using a server or cluster of servers. As another example, the controller 200 and user device 250 can be implemented using a combination of compute nodes and storage locations in a suitable cloud environment (e.g., as discussed further below). For example, one or more of the components of the controller 200 and user device 250 can be implemented using a public cloud, a private cloud, a hybrid cloud, or any other suitable implementation.

Although FIG. 2 depicts the compression service 212 and the compression ML training service 214 as being located in the memory 210, and the decompression service 262 as being located in the memory 260, that representation is also merely provided as an illustration for clarity. More generally, the controller 200 and user device 250 may include one or more computing platforms, such as computer servers for example, which may be co-located, or may form an interactively linked but distributed system, such as a cloud-based system, for instance. As a result, the processors 202 and 252, and the memories 210 and 260, may correspond to distributed processor and memory resources within the computing environment 100. Thus, it is to be understood that the compression service 212, the compression ML training service 214, and the decompression service 262, may be stored at any suitable location within the distributed memory resources of the computing environment 100.

FIG. 3 is a flowchart 300 illustrating image compression using a learning-based super resolution model, according to one embodiment. At block 302 a compression service (e.g., the compression service 212 illustrated in FIG. 1) transforms an input digital image. For example, the compression service can use a media transformation layer (e.g., the media transformation layer 114) to transform an input digital image into a lower resolution image. As discussed above in relation to the transformation layer 114 illustrated in FIG. 1, the compression service can use any suitable transformation technique to transform the input digital image into the lower resolution image, including a bicubic interpolation, a bilinear interpolation, a nearest-neighbor interpolation, or any other suitable transformation techniques. Alternatively, the compression service can use a learned transformation to produce a low resolution image which more optimally retains information in the original image (e.g., a trained deep-learning ML model, or any other suitable ML techniques). Training a learned transformation is discussed further, below, with regard to FIGS. 4-7.

At block 304, the compression service encodes the transformed image (e.g., using the encoder 118 illustrated in FIG. 1) to generate a latent representation of the image. As discussed above in relation to the encoder 118 illustrated in FIG. 1, in an embodiment the latent representation provides a minimum (or near-minimum) amount of data necessary to generate a final rendered image (e.g., at a destination). The compression service can be any suitable encoder. In an embodiment, the compression service uses a learned encoder (e.g., a deep learning ML encoder). Training a learned encoder is discussed further, below, with regard to FIGS. 4-7.

At block 306, the compression service transmits the latent representation of the image to a destination. As discussed above in relation to FIGS. 1-2, in an embodiment the compression service transmits the latent representation of the image from a source (e.g., a source application using a controller) to a destination (e.g., to a user device) using a suitable communication network.

At block 308 a decompression service (e.g., the decompression service 262 illustrated in FIG. 2) receives and decodes the image. In an embodiment, the decompression service receives the latent representation of the image, and uses a decoder (e.g., the decoder 132 illustrated in FIG. 1) to generate a lower resolution image from the latent representation. In an embodiment, the decompression service uses a decoder that corresponds to the encoder used at block 306 (e.g. the decoder is designed to decode the image data encoded using the encoder). The decompression service can use any suitable decoder. In an embodiment, the decompression service uses a learned decoder (e.g., a deep learning ML decoder). Training a learned decoder is discussed further, below, with regard to FIGS. 4-7.

At block 310 the decompression service transforms the decoded image to generate a reconstructed image (e.g., for presentation to a user). In an embodiment, the decompression service uses a super resolution transformation (e.g., the super resolution 136 illustrated in FIG. 1). For example, the decompression service can use a learned super resolution transformation to enhance a low resolution image to the end user device's higher resolution (e.g., a deep learning ML transformation). Training a learned super resolution transformation is discussed further, below, with regard to FIGS. 4-7.

In an embodiment the reconstructed image generated at block 310 corresponds to the input digital image transformed at block 302. For example, the reconstructed image can be a native resolution image for a destination device. The destination device (e.g., used to view the reconstructed image) can any suitable electronic or computing device, including a smartphone, a tablet, a laptop computer, a desktop computer, or any other suitable device. Further, the reconstructed image can have any suitable resolution.

FIG. 4 is a flowchart 400 illustrating training techniques for image compression using a learning-based super resolution model, according to one embodiment. In an embodiment, the ML models used for image compression (e.g., a described above in connection with FIG. 1) can be trained in multiple ways. At block 402, a user (e.g., a data scientist) or a compression ML training service (e.g., the compression ML training service 214 illustrated in FIG. 2) selects a training technique.

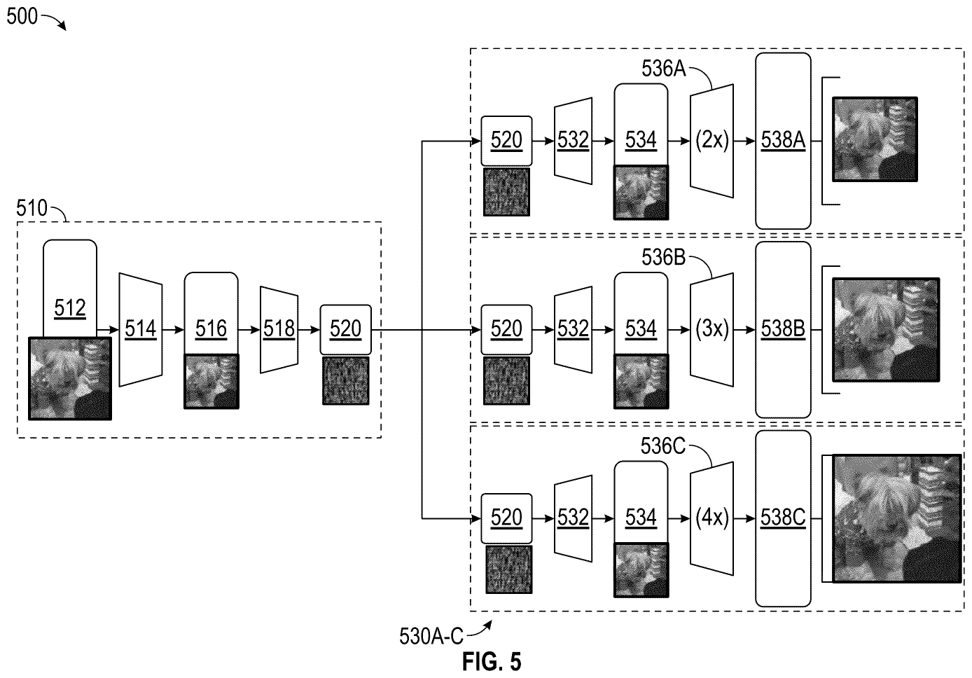

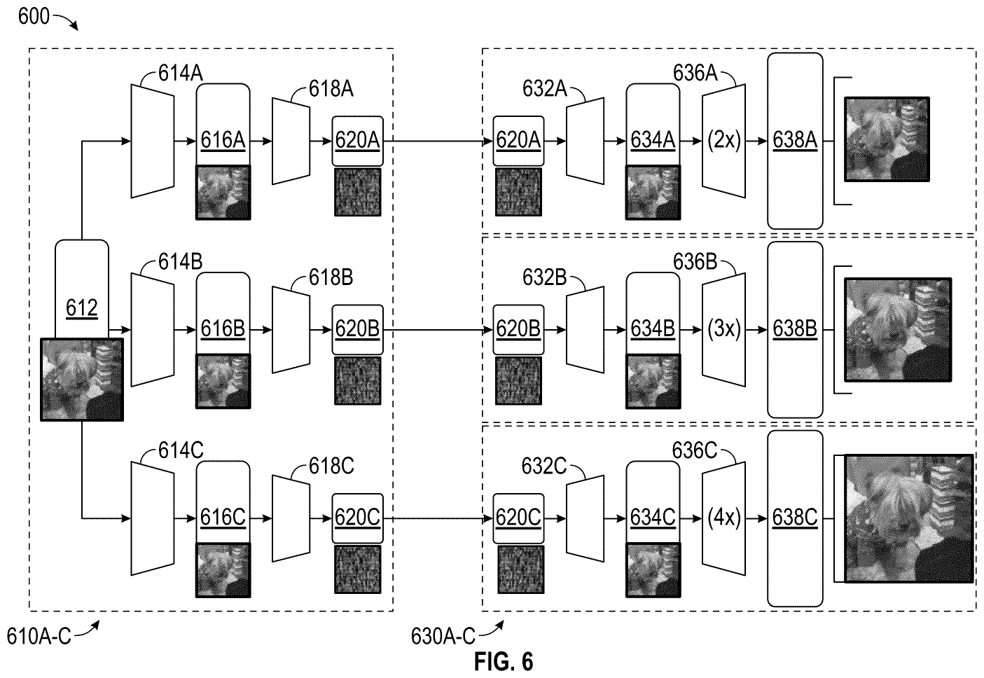

As illustrated in FIG. 4, the user (or software service) can select any of three options. At block 404, the compression ML training service uses a pretrained, frozen media transformation and encoder with a jointly trained super-resolution model to recover a high resolution output image. This is discussed further, below, with regard to FIG. 5. At block 406, the compression ML training service conducts individual end-to-end training of all submodules for every desired output resolution. This is discussed further, below, with regard to FIG. 6. At block 408, the compression ML training service conducts transferred end-to-end training. This is discussed further, below, with regard to FIG. 6. In an embodiment, the compression ML training service conducts any of these alternatives. Further, these are merely examples, and compression ML training service can conduct any suitable training technique.

In an embodiment, at block 420, the compression ML training service generates trained ML components. For example, the compression ML training service can generate, any, or all, of trained ML models for a media transformation layer (e.g., the media transformation 114 illustrated in FIG. 1), an encoder (e.g., the encoder 118 illustrated in FIG. 1), a decoder (e.g., the decoder 132 illustrated in FIG. 1), or a super-resolution transformation (e.g., the super-resolution 136 illustrated in FIG. 1). These trained ML models can be used for image compression and decompression (e.g., as discussed above in relation to FIGS. 1-3.

FIG. 5 illustrates a frozen media transformation and encoder with a jointly trained decoder for image compression using a learning-based super resolution model, according to one embodiment. In an embodiment, the training technique 500 uses a combination of pre-trained models along with jointly trained super-resolution to compress an input digital image 512 and generate any of a number of reconstructed images 538A-C, at a variety of resolutions. For example, the training technique 500 applies a media transformation 514 like downsampling, a pre-trained encoder 518, and a pre-trained decoder 532, then jointly trains super-resolution models 536 A-C to use to generate all of the reconstructed images 538A-C at various resolutions. The training technique 500, however, trains a separate super-resolution 536A-C corresponding to each target resolution of each reconstructed image 538A-C.

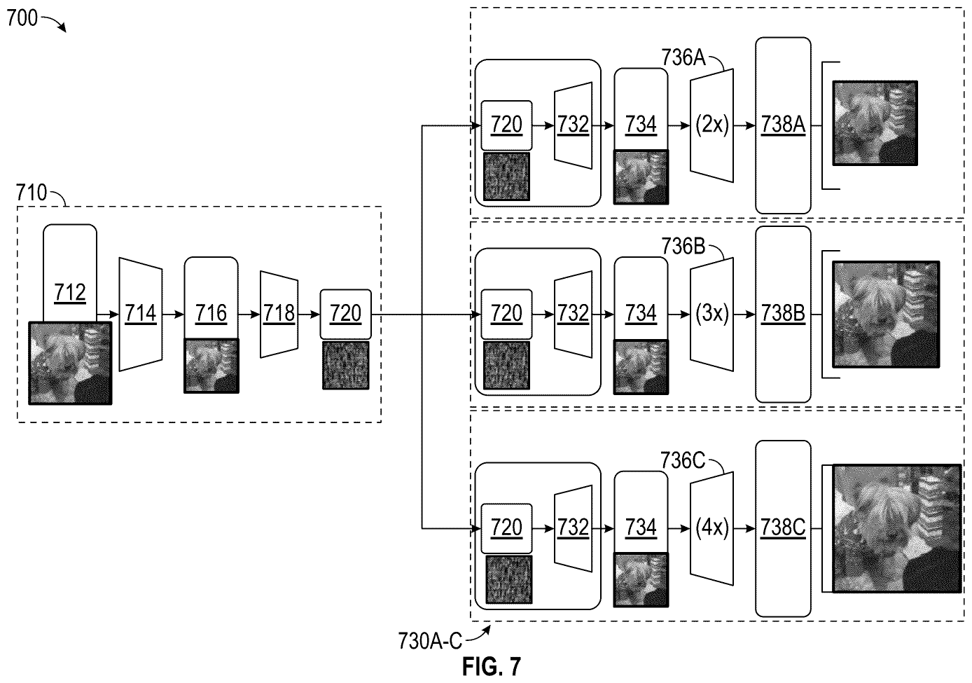

In an embodiment, the training technique 500 has advantages and disadvantages relative to other approaches (e.g., compared with the training techniques illustrated in FIGS. 6-7). For example, it provides for relatively fast training and saves computational resources because the media transformation, encoder, and decoder are shared for all image resolutions (e.g., rather than a separate media transformation, encoder, and decoder being trained for each reconstructed image resolution) and pretrained (e.g., rather than training models from scratch). Further, because these submodules are common across all resolutions, a source and destination need only store one media transformation, encoder, and decoder, for all resolutions. The source also need only store and transmit one encoded latent image data for each input digital image, because the same latent image data is used for a given input digital image regardless of the eventual target reconstructed image resolution. However, this combined training means that the reconstructed image may suffer, somewhat, in image quality compared to training a separate media transformation, encoder, and decoder for each reconstructed image resolution.

In more detail, a compression ML training service (e.g., the compression ML training service 214 illustrated in FIG. 2) selects a media transformation 514 to transform an input digital image 512 (e.g., an image, video frame, or collection of video frames) into a lower resolution image 516, an encoder 518 (e.g., a BMSHJ with hyperprior deep neural network) to encode the lower resolution image and generate a latent representation 520, and a decoder 532 to decode the latent representation 520 and generate a reconstructed lower resolution image 534 (e.g., after the latent representation 520 is transmitted from a compression block 510 to one or more of the decompression blocks 530A-C using a suitable communication network). The compression ML training service then trains a new super-resolution model (536A-C) to correct distortions introduced by the traditional and pretrained submodules and perhaps enhance the low resolution images to higher resolution corresponding to the desired output resolution.

For example, the compression ML training service can train these ML models 514, 518, and 532 together, using suitable training image data. This is merely an example, and any of the media transformation 514, encoder 518, and decoder 532 can instead be standard components that may or may not use ML models. Further, in an embodiment, the compression block 510 can implemented using a suitable controller (e.g., the controller 200 illustrated in FIG. 2) and can provide the latent representation 520, on-demand, to the decompression blocks 530A-C implemented using a suitable user device (e.g., the user device 250 illustrated in FIG. 2).

In an embodiment, the compression ML training service trains each super-resolution 536A-C, separately using suitable training image data, for a desired target resolution associated with a corresponding deconstructed image 538A-C. For example, the compression ML training service can train a first super-resolution 536A to output a reconstructed image 538A at a first target resolution corresponding to the desired output image. The compression ML training service can also train a second super-resolution 536B to output a reconstructed image 538B at a different target resolution. The compression ML training service can then train a third super-resolution 536C to output a reconstructed image 538C at another different resolution. In an embodiment, a given user device implementing the decompression blocks 530A-C includes a super-resolution (e.g., any combination of the super-resolutions 536A-C) corresponding to each target image resolution to display for that device.

FIG. 6 illustrates individual end to end training for image compression using a learning-based super resolution model, according to one embodiment. In an embodiment, the training technique 600 trains ML models to compress an input digital image 612 and, like the training technique 500 illustrated in FIG. 5, generate any of a number of reconstructed images 638A-C, at a variety of target resolutions. The training technique 600, however, trains a separate media transformation 614A-C, encoder 618A-C, and decoder 632A-C for each target image resolution associated with the respective reconstructed images 638A-C. The training technique also trains a separate super-resolution 636A-C for each resolution of each reconstructed image 638A-C.

In an embodiment, the training technique 600 has advantages and disadvantages (e.g., compared with the training techniques illustrated in FIGS. 5 and 7). For example, it may provide the highest image quality among the techniques illustrated in FIGS. 5-7, because a separate media transformation, encoder, and decoder is trained for each reconstructed image resolution, hence greater learning capacity for each individual model. But this training is very computationally expensive, and time consuming. Further, a recipient must maintain a separate decoder for each target image resolution, and a source must store and serve multiple different encoded latent image data depending on the target resolution. This can significantly increase storage requirements and computational and bandwidth burdens on the source.

In more detail, a compression ML training service (e.g., the compression ML training service 162 illustrated in FIG. 2) trains separate media transformations 614A-C to transform an input digital image 612 (e.g., an image, video frame, or collection of video frames) into a respective lower resolution image 616A-C. The compression ML training service also trains separate encoders 618A-C to generate respective latent representations 620A-C, and trains separate decoders 632A-C to generate respective reconstructed low resolution images 634A-C. The compression ML training service further trains separate super-resolutions 636A-C to generate fully reconstructed images 638A-C, at various resolutions, from the respective reconstructed lower resolution images 634A-C.

In an embodiment, each respective compression and decompression pipeline is trained to generate a reconstructed image at the target resolution. For example, the media transformation 614A, encoder 618A, decoder 632A, and super-resolution 636A are all trained (e.g., together using suitable training images) to generate the reconstructed image 638A at a target resolution. Similarly, the media transformation 614B, encoder 618B, decoder 632B, and super-resolution 636B are all trained (e.g., together using suitable training images) to generate the reconstructed image 638B at a different target resolution. The media transformation 614C, encoder 618C, decoder 632C, and super-resolution 636C are all trained (e.g., together using suitable training images) to generate the reconstructed image 638C at another different target resolution. This is merely an example, and any of the media transformations 614A-C, encoders 618A-C, and decoders 632A-C can instead be standard components that do not use ML models or trained separately.

In an embodiment, the compression blocks 610A-C transmit respective latent representations 620A-C to the corresponding decompression blocks 630A-C. In an embodiment, the compression blocks 610A-C can be implemented using a suitable controller (e.g., the controller 200 illustrated in FIG. 2) and can provide the latent representations 620A-C, on-demand, to the decompression blocks 630A-C implemented using a suitable user device (e.g., the user device 250 illustrated in FIG. 2).

FIG. 7 illustrates transferred end to end training for image compression using a learning-based super resolution model, according to one embodiment. In an embodiment, the training technique 700 trains ML models to compress an input digital image 712 and generate many reconstructed images 738A-C, at a variety of resolutions. For example, the training technique 700 trains a single media transformation 714, encoder 718, and decoder 732, to use to generate all of the reconstructed images 738A-C at various resolutions. The training technique 700 further trains one or a subset of super resolutions 736A-C to generate reconstructed images at a variety of desired resolutions. Further, the training technique 700 uses transfer learning to train additional super-resolutions 736A-C (e.g., additional to the initially trained super-resolution or subset of super-resolutions) for the respective target image resolutions.

In an embodiment, the training technique 700 has advantages and disadvantages (e.g., compared with the training techniques illustrated in FIGS. 5-6). For example, it provides for relatively fast training and saves computationally resources because one media transformation, encoder, and decoder is sufficient for supporting for all image resolutions (e.g., rather than a separate media transformation, encoder, and decoder being trained for each reconstructed image resolution). Further, a source and destination need only store one media transformation, encoder, and decoder, for all resolutions, and the source can transmit the same encoded latent image data to the destination regardless of the eventual target reconstructed image resolution. Additionally, the use of transfer learning to train the various super-resolutions for the various target image resolutions can further reduce training time and computational burden (e.g., compared to individual, fully end to end trained media transformation encoder, and decoders for each resolution, as illustrated in FIG. 6). This combined training means that the reconstructed image may suffer slightly in image quality for the transferred resolutions because the transformation, encoder and decoder are optimized for a different original resolution (e.g., compared with the techniques illustrated in FIG. 6). However, we expect this cost to be small or even non-existent. First, the jointly trained super-resolution model can learn to mitigate suboptimal representations in 734. Additionally, using one common representation of the low resolution image 734 can reduce overfitting, and thus improve generalization of the system on unseen data.

In more detail, a compression ML training service (e.g., the compression ML training service 162 illustrated in FIG. 2) trains a media transformation 714 to transform an input digital image 712 (e.g., an image, video frame, or collection of video frames) into a lower resolution image 716, an encoder 718 (e.g., a BMSHJ with hyperprior deep neural network) to encode the lower resolution image and generate a latent representation 720, and a decoder 732 to decode the latent representation 720 and generate a reconstructed lower resolution image 734 (e.g., after the latent representation 720 is transmitted from a compression block 710 to one or more of the decompression blocks 730A-C using a suitable communication network).

For example, the compression ML training service can jointly train these ML models 714, 718, 732, and at least one of 736A-C together, using suitable training image data. This is merely an example, and any of the media transformation 714, encoder 718, and decoder 732 can instead be standard components that do not use ML models. Further, in an embodiment, the compression block 710 can implemented using a suitable controller (e.g., the controller 200 illustrated in FIG. 2) and can provide the latent representation 720, on-demand, to the decompression blocks 730A-C implemented using a suitable user device (e.g., the user device 250 illustrated in FIG. 2).

In an embodiment, the compression ML training service further trains at least one of the super-resolutions 736A-C (or a subset of the super-resolutions 736A-C) jointly along with the media transformation 714, encoder 718, and decoder 732. The compression ML training service then uses transfer learning to train additional super-resolutions 736A-C, without requiring a full training session for each additional super-resolution. This is merely one example, and the compression ML training service can also use transfer learning to train separate decoders 732 (e.g., a separate decoder for each image resolution), separate encoders 718 (e.g., a separate encoder for each image resolution), or separate media transformations 714 (e.g., a separate media transformation for each image resolution).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For convenience, the Detailed Description includes the following definitions which have been derived from the “Draft NIST Working Definition of Cloud Computing” by Peter Mell and Tim Grance, dated Oct. 7, 2009.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

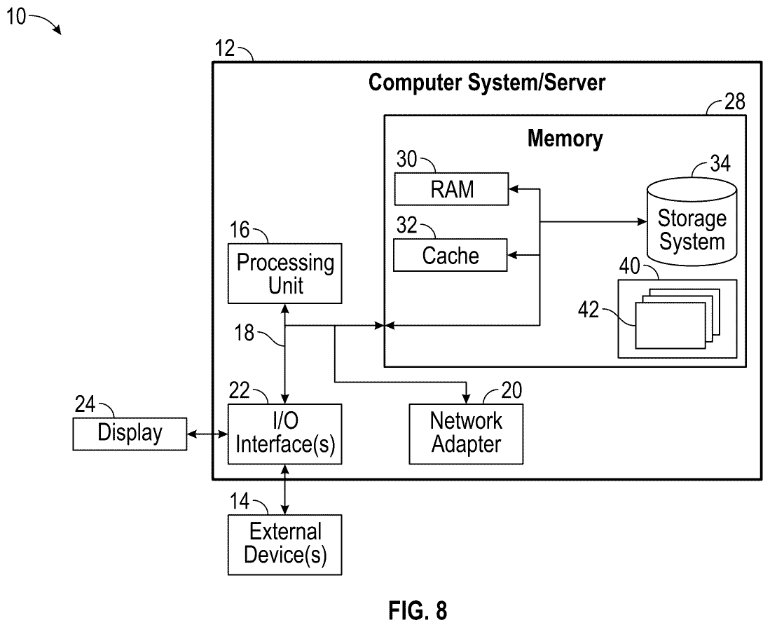

Referring now to FIG. 8, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

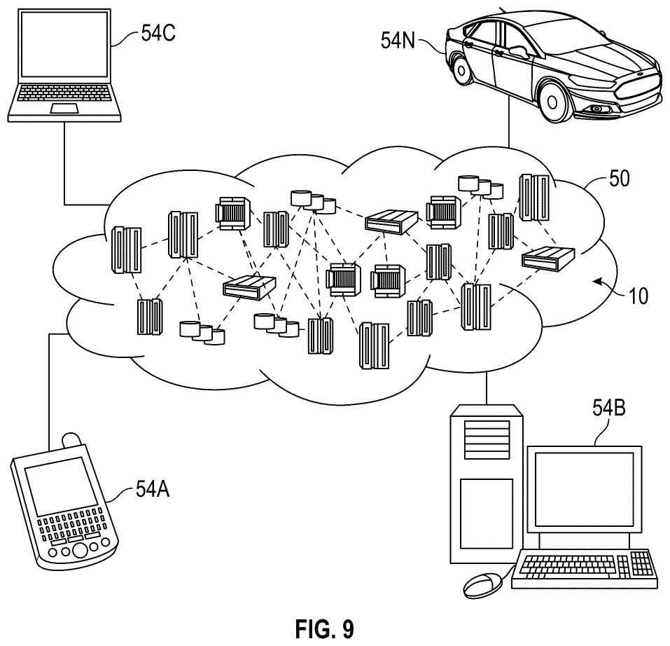

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

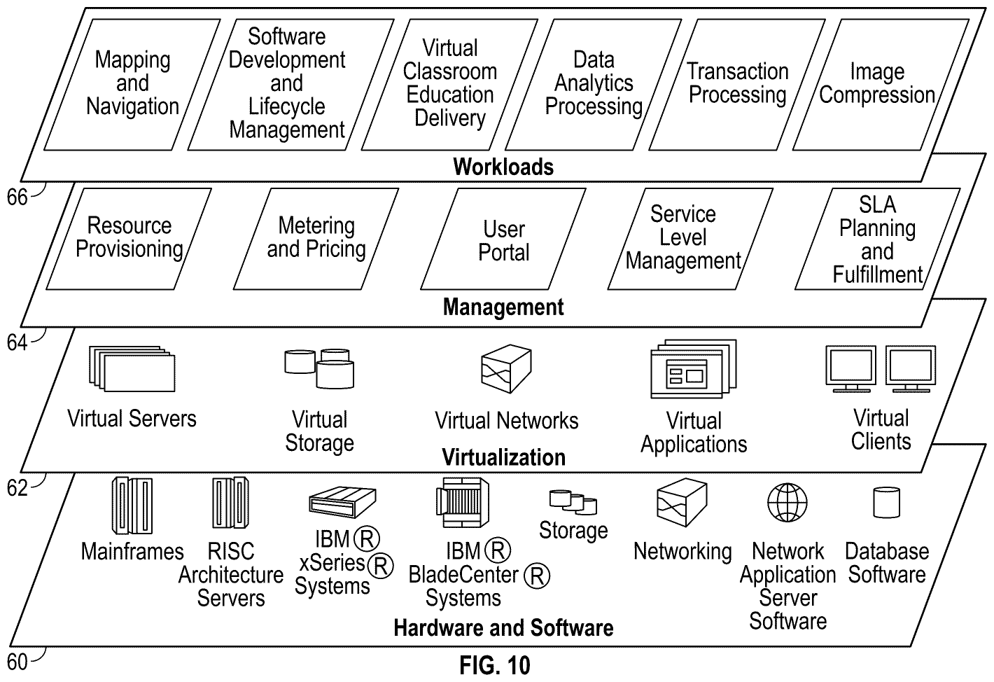

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide)

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and image compression. For example, the workloads layer 66 can implement some, or all, of the image compression functionality described above in relation to FIGS. 1-7.

While the foregoing is directed to embodiments of the present invention, other and further embodiments of the invention may be devised without departing from the basic scope thereof, and the scope thereof is determined by the claims that follow.

What is claimed is:

1. A computer-implemented method comprising:
receiving encoded image data, wherein the encoded image data was generated by encoding a first one or more digital images using an encoder;
generating a first reconstructed one or more digital images by decoding the encoded image data using a decoder corresponding to the encoder; and
generating a second reconstructed one or more digital images by transforming the first reconstructed one or more digital images using a super-resolution machine learning (ML) model,
wherein the second reconstructed one or more digital images has a higher image resolution compared with the first reconstructed one or more digital images, and
wherein the super-resolution ML model is trained based on an image resolution corresponding to at least one of the second reconstructed one or more digital images.

2. The computer-implemented method of claim 1, wherein
the encoder uses a first trained ML model to encode image and video data,
the decoder uses a second trained ML model to decode image data previously encoded using the encoder,
the encoder encodes a second one or more digital images generated using a media transformation layer to transform the first one or more digital images, and
the second one or more digital images are down-sampled from the first one or more digital images and have a lower resolution than the first one or more digital images.

3. The computer-implemented method of claim 2, wherein
the media transformation layer uses a third trained ML model to transform the first one or more digital images and generate the second one or more digital images.

4. The computer-implemented method of claim 2, wherein
the media transformation layer, the first trained ML model used by the encoder, and the second ML model used by the decoder are each respectively trained for reconstruction of images having a plurality of resolutions, and
the super-resolution ML model is one of a plurality of trained super-resolution ML models, each super-resolution ML model jointly trained with the encoder and decoder for reconstruction of images having a target resolution.

5. The computer-implemented method of claim 4, wherein
a first super-resolution ML model of the plurality of super-resolution ML models is trained using transfer-learning, based on a previously trained second super-resolution ML model of the plurality of super-resolution ML models.

6. The computer-implemented method of claim 2, wherein
the first trained ML model used by the encoder is one of a plurality of trained encoder ML models, each of the plurality of encoder ML models trained for reconstruction of images having a respective target resolution,
the second trained ML model used by the decoder is one of a plurality of trained decoder ML models, each of the plurality of decoder ML models trained for reconstruction of images having a respective target resolution, and
the super-resolution ML model is one of a plurality of trained super-resolution ML models, each super-resolution ML model trained for reconstruction of images having a respective target resolution.

7. The computer-implemented method of claim 1, further comprising:
receiving the encoded image data at an electronic computing device using a communication network; and
presenting the second reconstructed one or more digital images for display using a user-interface associated with the electronic computing device.

8. The computer-implemented method of claim 1, wherein,
the first one or more digital images comprise one or more frames in a digital video, and
the second reconstructed one or more digital images comprise one or more frames in the digital video corresponding to the first one or more digital images.

9. A system, comprising:
a processor; and
a memory having instructions stored thereon which, when executed on the processor, performs operations comprising:
receiving encoded image data, wherein the encoded image data was generated by encoding a first one or more digital images using an encoder;
generating a first reconstructed one or more digital images by decoding the encoded image data using a decoder corresponding to the encoder; and
generating a second reconstructed one or more digital images by transforming the first reconstructed one or more digital images using a super-resolution machine learning (ML) model,
wherein the second reconstructed one or more digital images has a higher image resolution compared with the first reconstructed one or more digital images, and
wherein the super-resolution ML model is trained based on an image resolution corresponding to at least one of the second reconstructed one or more digital images.

10. The system of claim 9, wherein
the encoder uses a first trained ML model to encode image data,
the decoder uses a second trained ML model to decode image data previously encoded using the encoder,
the encoder encodes a second one or more digital images generated using a media transformation layer to transform the first one or more digital images, and
wherein the second one or more digital images is down-sampled from the first one or more digital images and has a lower resolution than the first one or more digital images.

11. The system of claim 10, wherein
the media transformation layer, the first trained ML model used by the encoder, and the second ML model used by the decoder are each respectively trained for reconstruction of images having a plurality of resolutions, and
the super-resolution ML model is one of a plurality of trained super-resolution ML models, each super-resolution ML model jointly trained with the encoder and decoder for reconstruction of images having a target resolution.

12. The system of claim 10, wherein
a first super-resolution ML model of a plurality of super-resolution ML models is trained using transfer-learning, based on a previously trained second super-resolution ML model of the plurality of super-resolution ML models, and
each super-resolution ML model of the plurality of super-resolution ML models is jointly trained with the encoder and decoder for reconstruction of images having a target resolution.

13. The system of claim 10, wherein
the first trained ML model used by the encoder is one of a plurality of trained encoder ML models, each of the plurality of encoder ML models trained for reconstruction of images having a respective target resolution,
the second trained ML model used by the decoder is one of a plurality of trained decoder ML models, each of the plurality of decoder ML models trained for reconstruction of images having a respective target resolution, and
the super-resolution ML model is one of a plurality of trained super-resolution ML models, each super-resolution ML model trained for reconstruction of images having a respective target resolution.

14. The system of claim 9, wherein,
the first one or more digital images comprise one or more frames in a digital video, and
the second reconstructed one or more digital images comprise one or more frames in the digital video corresponding to the first one or more digital images.

15. A computer program product comprising:
a computer-readable storage medium having computer-readable program code embodied therewith, the computer-readable program code executable by one or more computer processors to perform operations, comprising:
receiving encoded image data, wherein the encoded image data was generated by encoding a first one or more digital images using an encoder;
generating a first reconstructed one or more digital images by decoding the encoded image data using a decoder corresponding to the encoder; and
generating a second reconstructed one or more digital images by transforming the first reconstructed one or more digital images using a super-resolution machine learning (ML) model,
wherein the second reconstructed one or more digital images has a higher image resolution compared with the first reconstructed one or more digital images, and
wherein the super-resolution ML model is trained based on an image resolution corresponding to at least one of the second reconstructed one or more digital images.

16. The computer program product of claim 15, wherein
the encoder uses a first trained ML model to encode image data,
the decoder uses a second trained ML model to decode image data previously encoded using the encoder,
the encoder encodes a second one or more digital images generated using a media transformation layer to transform the first one or more digital images, and
wherein the second one or more digital images is down-sampled from the first one or more digital images and has a lower resolution than the first one or more digital images.

17. The computer program product of claim 16, wherein
the media transformation layer, the first trained ML model used by the encoder, and the second ML model used by the decoder are each respectively trained for reconstruction of images having a plurality of resolutions, and
the super-resolution ML model is one of a plurality of trained super-resolution ML models, each super-resolution ML model jointly trained with the encoder and decoder for reconstruction of images having a target resolution.

18. The computer program product of claim 16, wherein
a first super-resolution ML model of a plurality of super-resolution ML models is trained using transfer-learning, based on a previously trained second super-resolution ML model of the plurality of super-resolution ML models, and
each super-resolution ML model of the plurality of super-resolution ML models is jointly trained with the encoder and decoder for reconstruction of images having a target resolution.

19. The computer program product of claim 16, wherein
the first trained ML model used by the encoder is one of a plurality of trained encoder ML models, each of the plurality of encoder ML models trained for reconstruction of images having a respective target resolution,
the second trained ML model used by the decoder is one of a plurality of trained decoder ML models, each of the plurality of decoder ML models trained for reconstruction of images having a respective target resolution, and
the super-resolution ML model is one of a plurality of trained super-resolution ML models, each super-resolution ML model trained for reconstruction of images having a respective target resolution.

20. The computer program product of claim 15, wherein,
the first one or more digital images comprise one or more frames in a digital video, and
the second reconstructed one or more digital images comprise one or more frames in the digital video corresponding to the first one or more digital images.
